(19) United States
(12) Patent Application Publication
(10) Pub. No.: US 2009/0234794 A1
(43) Pub. Date: Sep. 17, 2009

(54) METHOD FOR A CONTEXTUAL, VECTOR-BASED CONTENT-SERVING SYSTEM

(75) Inventor: Gregory Harrison, Seattle, WA (US)

Correspondence Address: BLACK LOWE & GRAHAM, PLLC, 701 FIFTH AVENUE, SUITE 4800, SEATTLE, WA, 98104, US

(73) Assignee: Mpire Corporation, Seattle, WA (US)

(21) Appl. No.: 12/233,491

(22) Filed: Sep. 18, 2008

Related U.S. Application Data
(60) Provisional application No. 60/973,393, filed on Sep. 18, 2007.

(51) Int. Cl. G06N 5/02

(52) U.S. Cl. 706/54

(57) ABSTRACT

Methods and systems of achieving contextual ad serving, without the need for this expansive infrastructure of storing every possible hosting URL, and ensuring always-current page context by evaluating the context of the hosting page/URL in real-time, for every ad impression. This is achievable by reversing the model by identifying the corpus of all terms relevant to the available ad inventory (i.e. a selective set of terms) rather than attempting to evaluate the corpus of all terms residing in the hosting page/URL.

### PRIORITY CLAIM

This application claims the benefit of U.S. Provisional Application Ser. No. 60/973,393 filed Sep. 18, 2007 and U.S. Provisional Application Ser. No. 60/986,680 filed Nov. 9, 2007, the contents of which are hereby incorporated by reference.

### BACKGROUND OF THE INVENTION

Most commonly-accepted methodologies relating to contextual web site analysis and ad serving conform to a specific (deferred analysis) model whereby the first request for an advertisement logs the hosting page URL to a deferred offline, queue-based system. In this traditional system, the first few ad requests are fulfilled with stock content or Public Service ads while the offline process works through a queue of all pending URLs to iteratively crawl the page and perform content analysis of the page to derive a specific contextual classification of the page/URL by examining the page content in its entirety—a very time/CPU-intensive evaluation. Once the context (and its corresponding ad content) is derived, the URL entry in the database is coded as such, such that further requests from this hosting page/URL can simply be referenced against this now-preclassified context to then serve appropriate content. This commonly accepted model requires an incredibly large scale of database and processing power at scale because the system must maintain a list of literally every possible URL that hosts an ad placement. The context value of the page is also limited by the frequency in which the hosting page/URL is re-evaluated for new content.

### SUMMARY OF THE INVENTION

The present invention provides an alternative method of achieving contextual ad serving, without the need for this expansive infrastructure of storing every possible hosting URL, and ensuring always-current page context by evaluating the context of the hosting page/URL in real-time, for every ad impression. This is achievable by reversing the model by identifying the corpus of all terms relevant to the available ad inventory (i.e. a selective set of terms) rather than attempting to evaluate the corpus of all terms residing in the hosting page/URL. The management of these selective set of terms (ContextBuckets), the manner in which these terms are associated with the appropriate ad content (Ad Content ->ContextBucket), and the mechanism for evaluating the hosting page/url against this set of selective terms (via the condensing of the term sets into the Tokenspace are the three primary claims in support of this filing.

### BRIEF DESCRIPTION OF THE DRAWINGS

Preferred and alternative examples of the present invention are described in detail below with reference to the following drawings:

FIG. 1 is a block diagram of an example system formed in accordance with an embodiment of the present invention; and

FIGS. 2-3 are flow diagrams showing processes performed by the system components shown in FIG. 1.

### DETAILED DESCRIPTION OF THE PREFERRED EMBODIMENT

The present invention provides as system and method for deriving contextually-relevant associations between groups of pre-defined content to a web page in which the content will be rendered for the purpose of delivering ad content to a web page with the highest possible context to the target page content. The invention allows highly relevant content to be delivered to a web page (i.e. advertising).

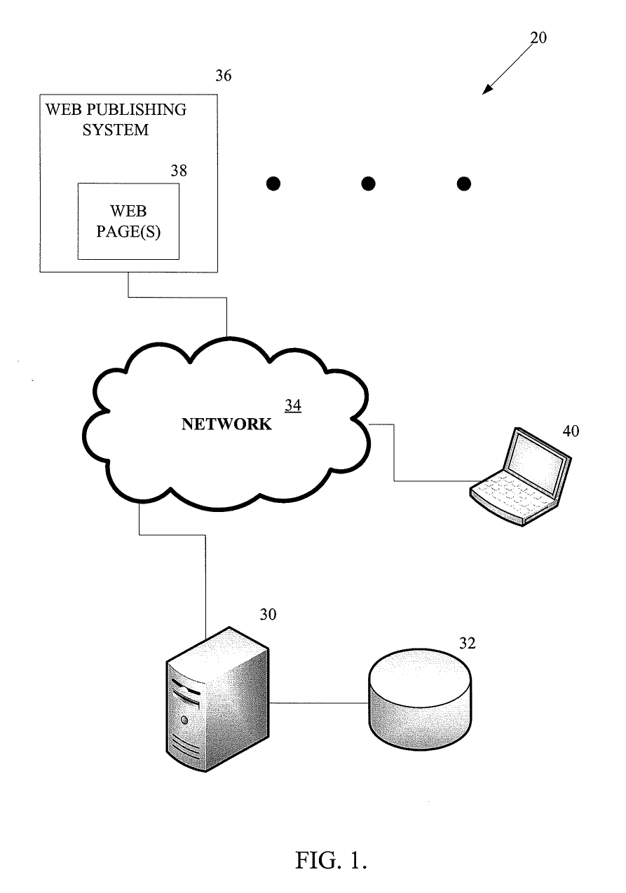

FIG. 1 illustrates a network environment 20 that includes components coupled to a network 34 for performing the above described service. The network environment 20 includes a web publishing system 36 that produces web content (web page(s) 38) available by user computer-based systems 40 over the network 34. A server 30 with memory 32 provides ad content from the server 30 (memory 32) to a user computer-based system 40 that has accessed a web page 38 that includes an ad content request.

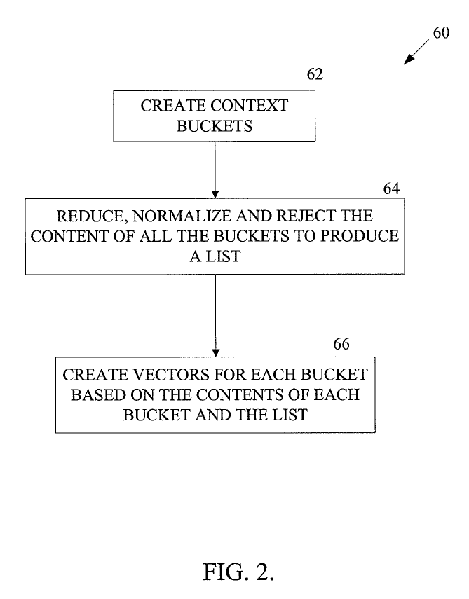

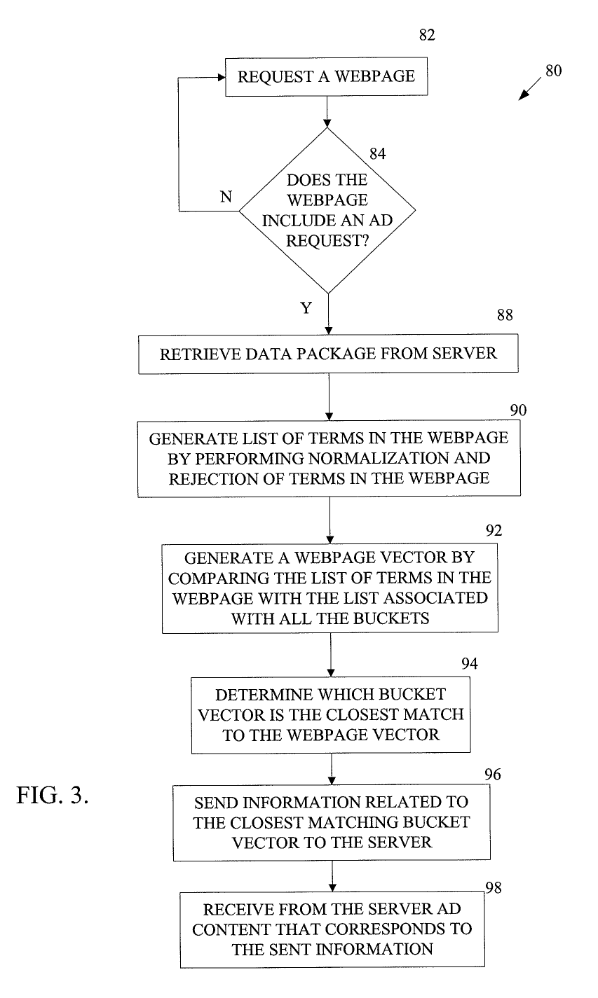

FIG. 2 illustrates a process 60 performed by the server 30 for creating a data package that is to be sent upon request to a web browser running on the user computer-based system 40 that has received the web page 38 that includes an ad content request. First, at block 62, one or more context buckets are created. Then, at block 64, the content of all the buckets is reduced, normalized and rejected based on predefined rules to produce a list. Next, at block 66, a vector is created for each bucket based on the contents of each bucket and the list. The list, the created vectors and an analyzer engine are included in the data package that is to be sent upon request. The analyzer engine is described in FIG. 3.

FIG. 3 illustrates a process 80 performed at least partially at the user computer-based system 40 (by the analyzer engine. First, at a block 82, a user requests a website (webpage 38) via a web browser running on their computer-based system 40. If the webpage 38 includes the ad request (i.e., a URL directed to the server 30), decision block 84, the data package is retrieved from the server 30 at block 88. Then, at block 90, at the web browser the analyzer engine generates a list of terms by performing normalization and rejection of terms in the webpage 38. Next, at block 92, the analyzer engine generates a webpage vector by comparing the list of terms in the webpage 38 with the list included in the data package. The analyzer engine determines which bucket vector is the closest match to the webpage vector, at block 94. At block 96, information related to the closest matching bucket vector is sent to the server 30. At block 98, the web browser receives ad content from the server that corresponds to the sent information from block 96 and the ad content is displayed in the webpage 38.

This method is herein referred to as the CLASS method. The CLASS method includes four basic object types: the TokenSpace, the ContextBucket, the Centroid, and the Document.

The ContextBucket serves as a named definition to be eventually associated with a collection of web content (ex: the advertisement content). The ContextBucket has two pieces of member data: a Name and a set of n-grams, which are used as a basis for generating a Centroid. The set of n-grams are descriptors for the ContextBucket.

The Centroid is a normalized representation of the ContextBucket. Normalization in this context is defined as one of many methods available for down-casting and/or stemming of n-grams combined with an accept/reject methodology for n-grams.

The TokenSpace is a union of all normalized n-grams of each Centroid, ordered by an ordering function (ex: a Latin alphabetical sort).

A source-document represents the content being evaluated for contextual mapping.

The Document represents the normalized version of the source-document that will be used for term-vector distancing against the Centroids in the TokenSpace.

The associations between these elements are visually represented in the FIGURE.

The CLASS method is described as follows:

At startup, the set of all defined ContextBuckets are iterated over and a Centroid is created for each ContextBucket. The set of n-grams is iterated over and each n-gram is either accepted or rejected by a Centroid building function. Accepted n-grams are then normalized via one or more pluggable normalization providers and are then added to the Centroid. One such example normalization would be keyword stemming (stemming is a process for reducing inflected (or sometimes derived) words to their stem, base or root form).

There now exists a set of “unfinished” Centroids SC={C0 . . . Cn}. Then, the union of all of the n-grams of each Centroid is determined. The n-grams in the union are ordered via an ordering function—typically the natural (Latin alphabetical) order of the n-grams can be used. This ordered union of all Centroids is called the TokenSpace.

Next, each Centroid is bound to the TokenSpace and a term vector is computed for each Centroid in the TokenSpace. A term vector in this context is a simple list of integers corresponding to the TokenSpace, where each member of the list is equal to the count of the occurrences of the corresponding term from the TokenSpace in the provided Centroid or Document.

As an example, assume there are two ContextBuckets:

ContextBucket 1

name: “Dogs”
n-gram candidates: “Puppy” “Labrador” “Golden Retriever”

“pet” “27”

ContextBucket 2

name: “Cats”
n-gram candidates: “Kitty” “Catnip” “Litter” “Pet” “Whiskers”

Assuming the rejection function was to only accept dictionary words and the normalization function was simply the down-casting function, the following language definition is attained:

L=[“catnip”, “golden retriever”, “kitty”, “Labrador”, “litter”, “pet”, “puppy”, “whiskers”]

Thus the following two Centroids would be cast as:

Centroid “Dogs”
n-grams: “puppy” “labrador” “golden retriever” “pet”

term-vector: [0,1,0,1,0,1,1,0]

Centroid “Cats”
n-grams: “kitty” “catnip” “litter” “pet” “whiskers”

term-vector: [1,0,1,0,1,1,0,1]

The system is then ready to accept documents for categorization/mapping against the Centroids.

When the system is asked to categorize a source-document, it passes the source document to a Tokenizer. The role of the Tokenizer is to present a set of n-gram candidates to a Document Builder. The Tokenizer uses the same normalization and rejection functions as were configured for the generation of Centroids to process all keywords in the document. Only those normalized keywords/n-grams from the source document that exist in the TokenSpace can be represented as candidates. The Document Builder then builds a Document to represent the source data. Thus, the Document represents a normalized set of matching n-grams from the source-document.

For example, if one were to attempt to categorize the contents of a (fictional) web page URL (http://www.kittylitter.com), the entirety of the page content is essentially reduced to a set of normalized n-grams derived from this document-source:

Document-source: http://www.kittylitter.com

n-grams: [“kitty”, “kitty”, “kitty”, “catnip”,

“catnip”, “pet”, “labrador”, “pet”, “whiskers”, “puppy”, “kitty”, “litter” ,
“litter” , “litter”]

term-vector: [2,0,4,1,4,2,1,1]

The document source URL, n-grams, and term-vector are constructed into a Document. Once this Document is constructed, it is passed to a BucketMapper, which categorizes the Document by mapping it to the Centroids in the system.

This mapping by the BucketMapper is performed by finding the Centroid with the “nearest-neighbor” term-vector to the requested Document in the TokenSpace.

Given the definition of the dot product:

a dot b=|a∥b|*cos(<ab)

Then:

<ab=a cos((a dot b)/(|a∥b|))

This formula is used to calculate the angles between each Centroid and the given Document, and the Centroid with the lowest angle is chosen as the Centroid for the Document. Since the Centroid is simply a normalized version of the ContextBucket, the desired mapping from source-document to ContextBucket exists.

Now that the association between the source-document (ex: http://www.kittylitter.com), its Document, and the mapped Centroid/ContextBucket have been derived, the ContextBucket can be used in association with the delivery of any desired web content.

For example, all ContextBuckets can be associated with one or more pieces of ad content. Once the source-document has been mapped to a ContextBucket, the associated ad content can be delivered to the source-document.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for creating a webpage ad analysis tool, the method comprising:
defining one or more context categories, each context category comprises one or more terms;
combining the terms of all the context categories;
normalizing the combined terms;
reducing the normalized terms to remove redundancy;
rejecting terms from the reduction based on predefined rules;
generating a list of terms based on the results of the rejection;
creating a vector for each context category based on the terms of each context category and the generated list; and
creating deliverable data package comprising the list, the created context category vectors and an analyzer engine,
wherein each context category is associated with a unique advertizing category, wherein each advertizing category includes associated ad content.

2. A method for analyzing a webpage and inserting ad content based on the analysis, the method comprising:
if a webpage accessed via a web browser includes an ad request, retrieving a data package from a server associated with the ad request, the data package comprises a list of normalized, reduced, and rejected content from one or more context categories, vectors associated with each of the one or more context categories based on the list and an analyzer engine;
generating a list of content by performing normalization and rejection of terms included in the accessed webpage;
generating a webpage vector by comparing the generated list of content with the list included in the data package;
determining the context category vector having the closest match to the webpage vector;
sending information related to the determined closest matching context category vector to the server;
receiving ad content from the server that corresponds to the sent information; and
displaying the received ad content in the webpage.

3. A system for creating a webpage ad analysis tool, the system comprising:
a means for defining one or more context categories, each context category comprises one or more terms;
a means for combining the terms of all the context categories;
a means for normalizing the combined terms;
a means for reducing the normalized terms to remove redundancy;
a means for rejecting terms from the reduction based on predefined rules;
a means for generating a list of terms based on the results of the rejection;
a means for creating a vector for each context category based on the terms of each context category and the generated list; and
a means for creating deliverable data package comprising the list, the created context category vectors and an analyzer engine,
wherein each context category is associated with a unique advertizing category, wherein each advertizing category includes associated ad content.

4. A system for analyzing a webpage and inserting ad content based on the analysis, the system comprising:
if a webpage accessed via a web browser includes an ad request, a means for retrieving a data package from a server associated with the ad request, the data package comprises a list of normalized, reduced, and rejected content from one or more context categories, vectors associated with each of the one or more context categories based on the list and an analyzer engine;
a means for generating a list of content by performing normalization and rejection of terms included in the accessed webpage;
a means for generating a webpage vector by comparing the generated list of content with the list included in the data package;
a means for determining the context category vector having the closest match to the webpage vector;
a means for sending information related to the determined closest matching context category vector to the server;
a means for receiving ad content from the server that corresponds to the sent information; and
a means for displaying the received ad content in the webpage.
